(19) United States
(12) Patent Application Publication
(10) Pub. No.: US 2026/0088209 A1
(43) Pub. Date: Mar. 26, 2026

(54) ELECTRONIC COMPONENT

(71) Applicant: TDK Corporation, Tokyo (JP)

(72) Inventors: Munehiro TAKAKU, Tokyo (JP); Kazuya TOBITA, Tokyo (JP); Shinnosuke SUZUKI, Tokyo (JP); Tomohiro KAITO, Tokyo (JP)

(73) Assignee: TDK Corporation, Tokyo (JP)

(21) Appl. No.: 19/325,091

(22) Filed: Sep. 10, 2025

(30) Foreign Application Priority Data
Sep. 20, 2024 (JP) 2024-164084

(51) Int. Cl. H01F 27/28; H01F 27/29

(52) U.S. Cl. CPC H01F 27/2804; H01F 27/29; H01F 2027/2809

(57) ABSTRACT

An electronic component includes an element body and a pair of external conductors located on the element body. The element body includes a pair of end faces opposing each other in a first direction, a pair of first side faces opposing each other in a second direction, and a pair of second side faces opposing each other in a third direction. A length of each of the pair of end faces in a second direction and a length of each of the pair of end faces in a third direction are equal. A surface color of one of the pair of second side faces is different from a surface color of the other of the pair of second side faces and is different from a surface color of each of the pair of first side faces.

### CROSS-REFERENCE TO RELATED APPLICATIONS

This application is based upon and claims the benefit of priority from Japanese Patent Application No. 2024-164084, filed on Sep. 20, 2024, the entire contents of which are incorporated herein by reference.

### BACKGROUND

### Field

The present disclosure relates to an electronic component.

### Description of the Related Art

International Publication No. 2015/016079 discloses an electronic component that includes an element body, a pair of external conductors located on the element body, a coil located in the element body, and a pair of internal conductors that connect the coil and the external conductors. The element body has a pair of end faces opposing each other in a first direction, a pair of first side faces opposing each other in a second direction orthogonal to the first direction, and a pair of second side faces opposing each other in a third direction orthogonal to the first direction and the second direction. The coil is located such that a coil axis of the coil intersects the pair of second side faces.

### SUMMARY

It is difficult to determine the orientation of an electronic component from its appearance if the first side faces and the second side faces have the same shape. For example, if the orientation of the electronic component cannot be confirmed when accommodating the electronic component in a carrier tape or when mounting it on an electronic device, a mounting failure may occur.

One aspect of the present disclosure is to provide an electronic component that facilitates confirmation of its orientation.

An electronic component according to one aspect of the present disclosure includes an element body and a pair of external conductors located on the element body. The element body includes a pair of end faces opposing each other in a first direction, a pair of first side faces opposing each other in a second direction, and a pair of second side faces opposing each other in a third direction. The second direction is orthogonal to the first direction. The third direction is orthogonal to the first direction and the second direction. A length of each of the pair of end faces in the second direction and a length of each of the pair of end faces in the third direction are equal. A surface color of one of the pair of second side faces is different from a surface color of the other of the pair of second side faces and is different from a surface color of each of the pair of first side faces.

In the one aspect described above, the second direction and the third direction are orthogonal to each other, and the second direction and the third direction are each orthogonal to the first direction. Therefore, a length of each of the pair of first side faces opposing each other in the second direction in the first direction and a length of each of the pair of second side faces opposing each other in the third direction in the first direction are equal.

Since the first direction and the second direction are orthogonal to each other, and the first direction and the second direction are each orthogonal to the third direction, a length of each of the pair of end faces in the third direction and a length of each of the pair of first side faces in the third direction are equal.

Since the first direction and the third direction are orthogonal to each other, and the first direction and the third direction are each orthogonal to the second direction, a length of each of the pair of end faces in the second direction and a length of each of the pair of second side faces in the second direction are equal.

Therefore, the length of each of the end faces and the first side faces in the third direction is equal, and the length of each of the end faces and the second side faces in the second direction is equal. As a result, in a configuration where the length of each of the pair of end faces in the second direction and the length of each of the pair of end faces in the third direction are equal, the length of the first side faces in the third direction and the length of the second side faces in the second direction are equal. Since the length of each edge defining the first side face and the length of each edge defining the second side face are equal, the first side faces and the second side faces have the same shape.

In the one aspect described above, the surface color of the one of the pair of second side faces is different from the surface color of the other of the pair of second side faces and is different from the surface color of each of the pair of first side faces. Therefore, even if the first side faces and the second side faces have the same shape, because the surface color of the one of the pair of second side faces is different from the surface color of the other side faces, the electronic component facilitates confirmation of its orientation.

### BRIEF DESCRIPTION OF THE DRAWINGS

FIG. 1 is a perspective view of an electronic component according to an embodiment;

FIG. 2 is a perspective view of the electronic component according to the present embodiment;

FIG. 3 is a side view of the electronic component according to the present embodiment as viewed from one side face;

FIG. 4 is an end view of the electronic component according to the present embodiment as viewed from one end face; and

FIG. 5 is a side view of the electronic component according to the present embodiment as viewed from another side face.

### DETAILED DESCRIPTION

Hereinafter, examples of the present disclosure will be described in detail with reference to the accompanying drawings. In the following description, the same components or components having the same functions are denoted with the same reference numerals and overlapping explanation is omitted.

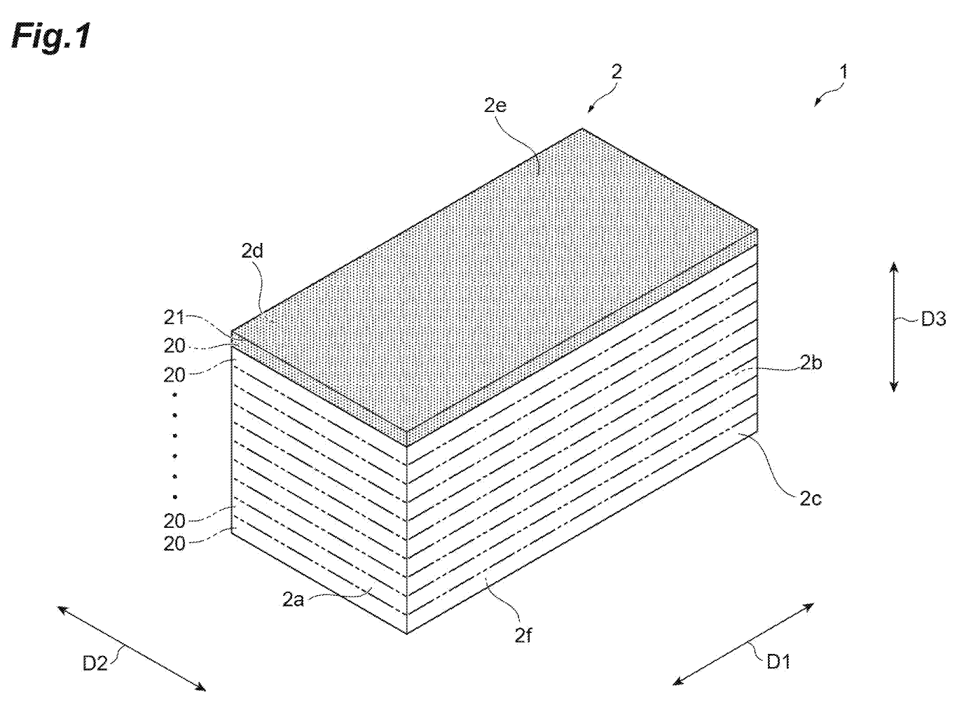

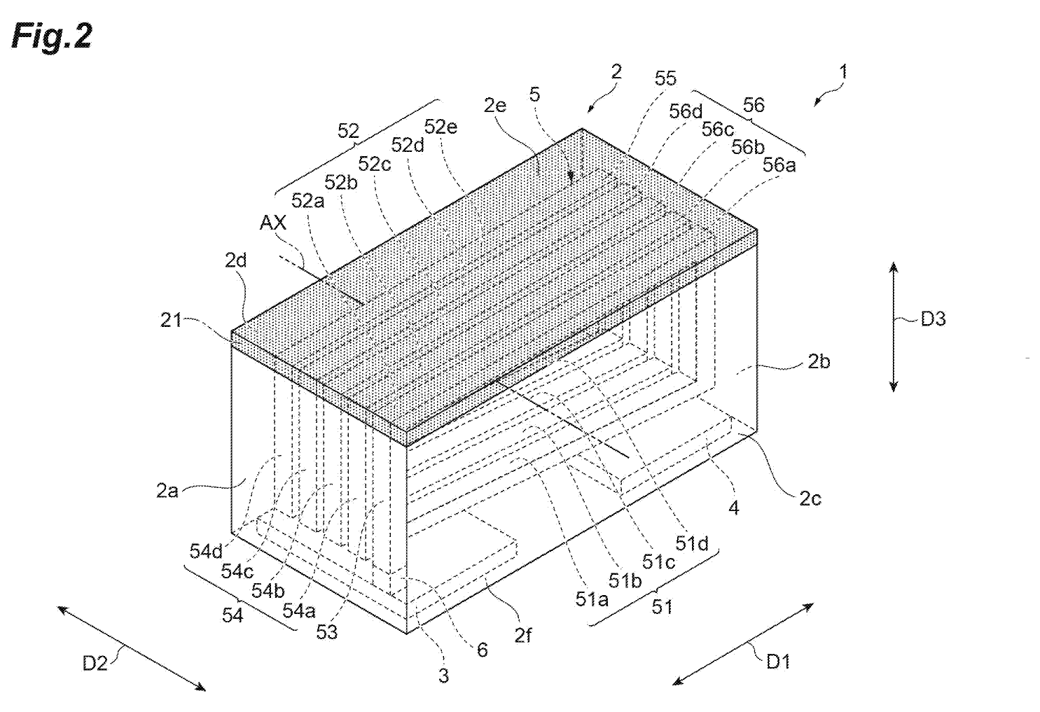

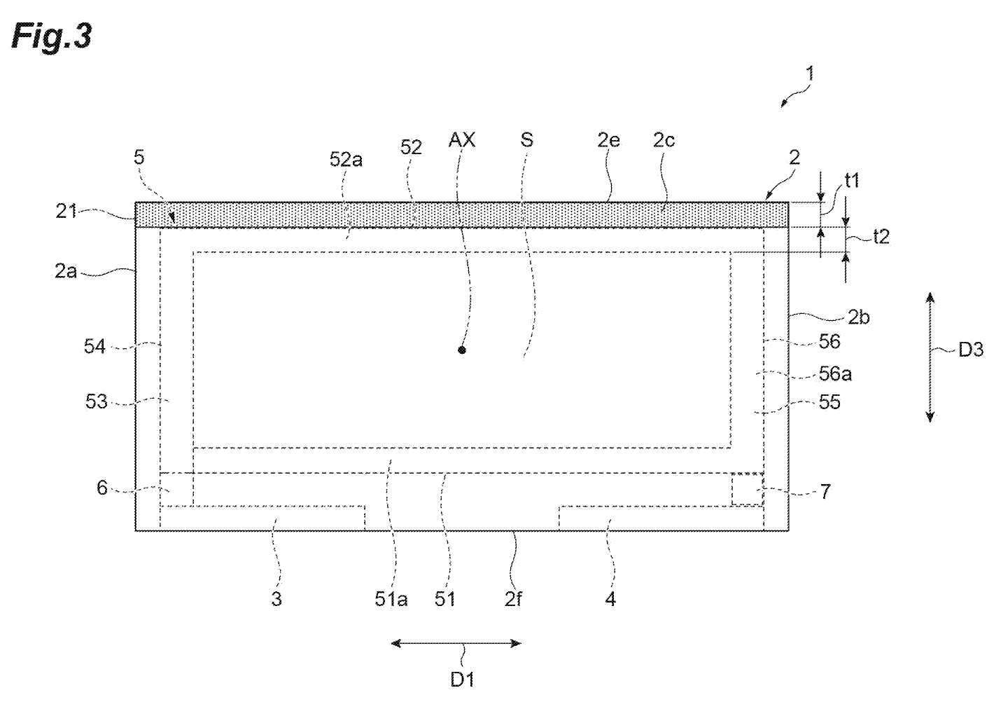

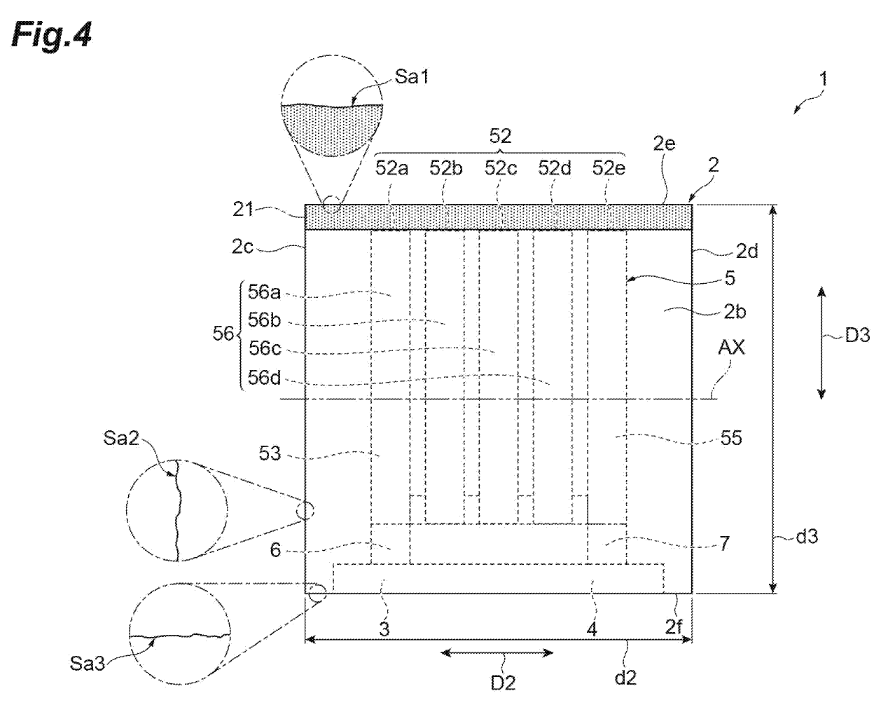

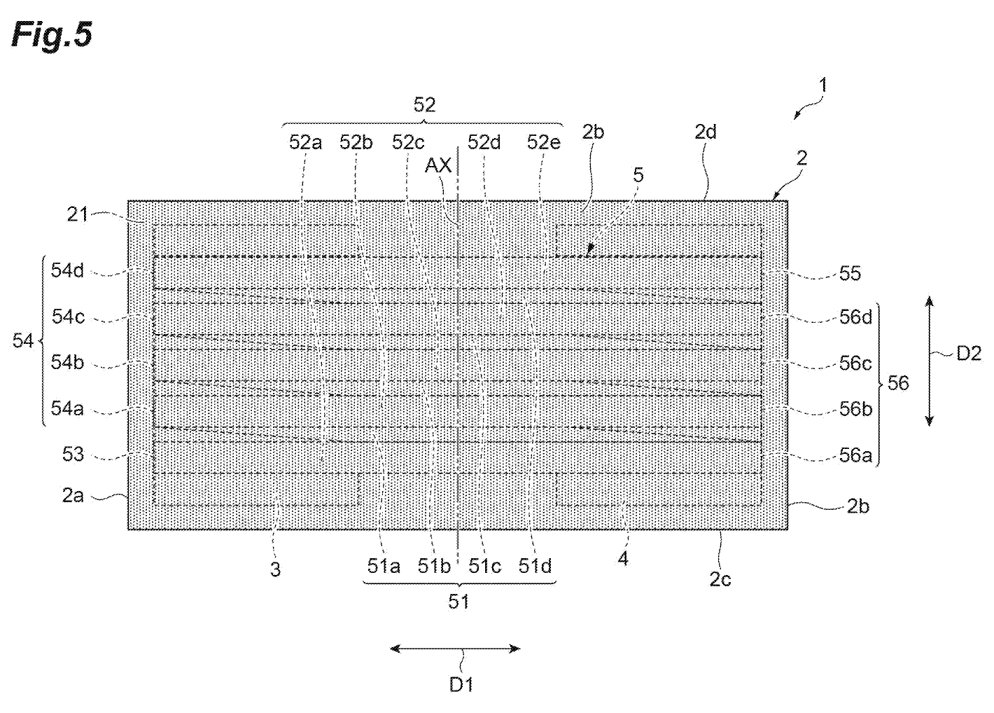

A configuration of the electronic component according to the present embodiment will be described with reference to FIG. 1 to FIG. 5. FIG. 1 and FIG. 2 are perspective views of the electronic component according to the present embodiment. FIG. 3 is a side view of the electronic component according to the present embodiment as viewed from a side face 2c shown in FIG. 1. FIG. 4 is an end view of the electronic component according to the present embodiment as viewed from an end face 2b shown in FIG. 1. FIG. 5 is a side view of the electronic component according to the present embodiment as viewed from a side face 2e shown in FIG. 1. The electronic component 1 according to the present embodiment is solder-mounted on an electronic device. The electronic device includes, for example, a circuit board or another electronic component. As shown in FIG. 1 to FIG. 5, the electronic component 1 includes an element body 2, an external conductor 3, an external conductor 4, a coil 5, an internal conductor 6, and an internal conductor 7. The electronic component 1 is a coil component including the coil 5.

The element body 2 has a rectangular parallelepiped shape. The rectangular parallelepiped shape includes a shape of a rectangular parallelepiped in which corners and ridge portions are chamfered and rounded. The element body 2 includes an end face 2a and an end face 2b opposing each other, a side face 2c and a side face 2d opposing each other, and a side face 2e and a side face 2f opposing each other. The side face 2c and the side face 2d and the side face 2e and the side face 2f connect the end face 2a and the end face 2b. The side face 2c and the side face 2d and the side face 2e and the side face 2f are adjacent to each other via corners or ridge portions. The pair of end face 2a and end face 2b oppose each other in a direction D1. The pair of side faces 2c and 2d oppose each other in a direction D2. The pair of side faces 2e and 2f oppose each other in a direction D3. The direction D2 is orthogonal to the direction D1. The direction D3 is orthogonal to the direction D1 and the direction D2.

For example, the direction D1 includes a first direction, the direction D2 includes a second direction, and the direction D3 includes a third direction. For example, the pair of side faces 2c and 2d includes a pair of first side faces, and the pair of side faces 2e and 2f includes a pair of second side faces.

Referring to FIG. 4, a length d2 of each of the pair of end faces 2a, 2b in the direction D2 and a length d3 of each of the pair of end faces 2a, 2b in the direction D3 are equal. The term "equal" includes not only being identical but also values that may have a slight difference within a preset range or a manufacturing variation. For example, if a difference between the length d2 and the length d3 is within a range of ±5% of the length d2 or the length d3, the length d2 and the length d3 are defined as being equal. In one example, the difference between the length of each of the pair of end faces 2a, 2b in the direction D2 and the length of each of the pair of end faces 2a, 2b in the direction D3 is 20 μm or less. The end faces 2a, 2b each have a square shape. The length of each of the side face 2c and the side face 2d in the direction D3 and the length of each of the side face 2e and the side face 2f in the direction D2 are equal. The length of each of the side face 2c and the side face 2d in the direction D1 and the length of each of the side face 2e and the side face 2f in the direction D1 are equal. Each of the side faces 2c, 2d, 2e, and 2f may have a rectangular shape with a side along the direction D1 as a long side. Since the length of each edge defining each of the side faces 2c and 2d is equal to the length of each edge defining each of the side faces 2e and 2f, the side faces 2c, 2d, 2e, and 2f have the same shape.

The element body 2 includes a plurality of insulator layers 20 having electrical insulation properties. As shown in FIG. 1, in the present embodiment, the element body 2 includes the plurality of insulator layers 20 laminated along the direction D3. In an actual element body 2, the plurality of insulator layers 20 are integrated to such an extent that their boundaries are not visible. The plurality of insulator layers 20 include an outer layer 21 located at one end in the direction D3. The outer layer 21 includes the side face 2e. Each of the plurality of insulator layers 20 has, for example, a rectangular shape when viewed from the direction D3. For example, the side face 2e includes one of the pair of second side faces.

Each insulator layer 20 is composed of, for example, a sintered body of a ceramic green sheet containing a ferrite material. The ferrite material includes, for example, a Ni-Cu-Zn based ferrite material, a Ni-Cu-Zn-Mg based ferrite material, or a Ni-Cu based ferrite material. Each insulator layer 20 may include an Fe alloy. Each insulator layer 20 may include a non-magnetic material. The non-magnetic material includes, for example, a glass ceramic material or a dielectric material. Each insulator layer 20 may include a resin material. The resin material includes, for example, at least one selected from the group consisting of liquid crystal polymer, a polyimide resin, a crystalline polystyrene, an epoxy-based resin, an acrylic-based resin, a bismaleimide-based resin, and a fluorine-based resin. The resin material may include, for example, a filler. The filler includes, for example, an inorganic filler. The inorganic filler includes silica. The resin material may not include a filler. Each insulator layer 20 may include a colorant, a pigment, or a dye.

A surface color of the side face 2e is different from a surface color of the side face 2f and is different from a surface color of each of the side faces 2c and 2d. The surface color indicates the color appearance of reflected light reflected from the surface of an object. The surface color includes an inherent color appearance of the object and a color appearance due to the surface state of the object. The color due to the surface state of the object includes a structural color appearance of the object and a color appearance due to the surface roughness of the object. The surface color may be indicated by a value in a color space. For example, a value of the side face 2e in a color space is different from a value of the side face 2f in the color space and is different from a value of each of the side faces 2c and 2d in the color space. The value of the side face 2e in the color space may differ from the value of the side face 2f in the color space and the value of each of the side faces 2c and 2d in the color space by a predetermined threshold or more. As shown in FIG. 1, in the present embodiment, The surface color of the outer surface of the outer layer 21 includes the surface color of the side face 2e. The surface color of the outer layer 21 is different from a surface color of each of the plurality of insulator layers 20 excluding the outer layer 21.

An entire surface of the side face 2e may have the surface color that is different from the surface color of the side face 2f and the surface color of each of the side faces 2c and 2d. An area of 10% or more of the side face 2e may have the surface color that is different from the surface color of the side face 2f and the surface color of each of the side faces 2c and 2d. The center of the side face 2e may have the surface color that is different from the surface color of the side face 2f and the surface color of each of the side faces 2c and 2d.

The side face 2e is colored with a surface color different from the surface color of the side face 2f and the surface color of each of the side faces 2c and 2d. For example, the side face 2e is colored with a surface color that is different from the surface color of the side face 2f and each of the side faces 2c and 2d. This difference in color is in at least one attribute selected from the group consisting of lightness, hue, and saturation. The side face 2e may be colored by a dye. The side face 2e may be colored by heat treatment.

As shown in FIG. 4, a surface roughness Sa1 of the side face 2e may be different from a surface roughness Sa3 of the side face 2f and a surface roughness Sa2 of each of the side face 2c and the side face 2d. The surface roughness may include an arithmetic mean height Sa. The surface color and the surface roughness are correlated. When the surface roughness is high, the influence of specularly reflected light on the surface color decreases, and the influence of diffusely reflected light on the surface color increases. When the surface roughness is high, the lightness of the surface color may decrease. The surface roughness Sa1 of the side face 2e may be lower than the surface roughness Sa3 of the side face 2f and the surface roughness Sa2 of each of the side faces 2c and 2d. The surface roughness Sa1 of the side face 2e may be higher than the surface roughness Sa3 of the side face 2f and the surface roughness Sa2 of each of the side faces 2c and 2d.

The outer layer 21 is colored with the surface color different from the surface color of each of the plurality of insulator layers 20 excluding the outer layer 21. For example, the outer layer 21 is colored with the surface color that is different from the surface color of each of the plurality of insulator layers 20 excluding the outer layer 21. This difference in color is in at least one attribute selected from the group consisting of lightness, hue, and saturation. For example, the outer layer 21 or each of the plurality of insulator layers 20 excluding the outer layer 21 is colored by a colorant, a pigment, a dye, or a filler. The outer layer 21 may include a colorant, the pigment, the dye, or the filler. Each of the plurality of insulator layers 20 excluding the outer layer 21 may include a colorant, a pigment, or a dye. An amount of filler contained in the outer layer 21 and an amount of filler contained in each of the plurality of insulator layers 20 excluding the outer layer 21 may be different. The amount of filler contained in the outer layer 21 may be larger than the amount of filler contained in each of the plurality of insulator layers 20 excluding the outer layer 21. The amount of filler contained in the outer layer 21 may be smaller than the amount of filler contained in each of the plurality of insulator layers 20 excluding the outer layer 21.

The pair of external conductors 3 and 4 are located on the element body 2. In the present embodiment, the pair of external conductors 3 and 4 are located on the side face 2f. When the electronic component 1 is solder-mounted on an electronic device, the external conductors 3 and 4 are connected to terminals of the electronic device. For example, the side face 2f includes the other of the pair of second side faces. When the electronic component 1 is solder-mounted on an electronic device, the side face 2f faces the electronic device on which it is to be solder-mounted.

The external conductors 3 and 4 are arranged apart in the direction D1. The external conductor 3 is located near the end face 2a, and the external conductor 4 is located near the end face 2b. In the present embodiment, the pair of external conductors 3 and 4 are located only on the side face 2f. The external conductors 3 and 4 are respectively located in a pair of depressions formed in the side face 2f. When viewed from the direction D3, the external conductors 3 and 4 are spaced apart from an outer edges of the side face 2f. When viewed from the direction D3, the external conductors 3 and 4 have a rectangular shape. The external conductors 3 and 4 have a long edge along the direction D2 and a short edge along the direction D1.

The external conductors 3 and 4 include a conductive material. The conductive material includes, for example, Ag, Pd, Cu, or Al. The conductive material includes, for example, an Ag-Pd alloy, an Ag-Cu alloy, an Ag-Au alloy, or an Ag-Pt alloy. The external conductors 3 and 4 include, for example, a Ni plating film, an Sn plating film, a Cu plating film, or an Au plating film. The external conductors 3 and 4 may have a multilayer structure of the plating films described above, and may include a Ni plating film and an Sn plating film formed on the Ni plating film. The plating film is formed by, for example, an electrolytic plating method or an electroless plating method.

The coil 5 is located in the element body 2. A coil axis AX of the coil 5 intersects the pair of side faces 2c and 2d. For example, the coil axis AX is the central axis of the coil 5 and has infinite length. In the present embodiment, the coil axis AX of the coil 5 is along the direction D2. The coil 5 has a spiral shape centered on the coil axis AX. The coil 5 has a plurality of coil conductors located so as to have a spiral shape centered on the coil axis AX. The coil 5 has at least one coil conductor 51, at least one coil conductor 52, a coil conductor 53, at least one coil conductor 54, a coil conductor 55, and at least one coil conductor 56. As shown in FIG. 3, when viewed from the direction D2, the coil 5 has a rectangular shape. The coil 5 includes the conductive material described above. The coil 5, the pair of internal conductors 6 and 7, and the pair of external conductors 3 and 4 are electrically connected.

The at least one coil conductor 51 is adjacent to the side face 2f. The at least one coil conductor 51 includes a conductor 51a, a conductor 51b, a conductor 51c, and a conductor 51d. The conductors 51a, 51b, 51c, and 51d extend along the direction D1. The conductors 51a, 51b, 51c, and 51d are arranged in the direction D2. The conductor 51a is located at an end close to the side face 2c in the direction D2, and the conductor 51d is located at an end close to the side face 2d in the direction D2.

The at least one coil conductor 52 is adjacent to the side face 2e. The at least one coil conductor 52 includes a plurality of conductors. The at least one coil conductor 52 includes a conductor 52a, a conductor 52b, a conductor 52c, a conductor 52d, and a conductor 52e. The conductors 52a, 52b, 52c, 52d, and 52e each extend along the direction D1. The conductors 52a, 52b, 52c, 52d, and 52e are arranged in the direction D2. The conductor 52a is located at an end close to the side face 2c in the direction D2, and the conductor 52e is located at an end close to the side face 2d in the direction D2. For example, the at least one coil conductor 52 includes at least one coil conductor.

The coil conductor 53 connects the conductor 52a and the internal conductor 6. The coil conductor 53 is connected to the external conductor 3 via the internal conductor 6. The coil conductor 53 is adjacent to the end face 2a. The coil conductor 53 extends along the direction D3. In the coil 5, the coil conductor 53 is located at an end close to the side face 2c in the direction D2.

The coil conductor 55 connects the conductor 52e and the internal conductor 7. The coil conductor 55 is connected to the external conductor 4 via the internal conductor 7. The coil conductor 55 is adjacent to the end face 2b. The coil conductor 55 extends along the direction D3. In the coil 5, the coil conductor 55 is located at an end close to the side face 2d in the direction D2.

The at least one coil conductor 54 connects the at least one coil conductor 51 and the at least one coil conductor 52. The at least one coil conductor 54 is adjacent to the end face 2a. The at least one coil conductor 54 includes a conductor 54a, a conductor 54b, a conductor 54c, and a conductor 54d. As shown in FIG. 5, a shortest distance between the conductors 54a, 54b, 54c, 54d and the end face 2a and a shortest distance between the external conductor 3 and the end face 2a may be equal. The conductors 54a, 54b, 54c, and 54d extend along the direction D3. The conductors 54a, 54b, 54c, and 54d are arranged in the direction D2. The conductor 54d is located at an end close to the side face 2d. The conductor 54a is adjacent to the coil conductor 53 in the direction D2.

The at least one coil conductor 56 connects the at least one coil conductor 51 and the at least one coil conductor 52. The at least one coil conductor 56 is adjacent to the end face 2b. The at least one coil conductor 56 includes a conductor 56a, a conductor 56b, a conductor 56c, and a conductor 56d. As shown in FIG. 5, a shortest distance between the conductors 56a, 56b, 56c, 56d and the end face 2b and a shortest distance between the external conductor 4 and the end face 2b may be equal. The conductors 56a, 56b, 56c, and 56d extend along the direction D3. The conductors 56a, 56b, 56c, and 56d are arranged in the direction D2. The conductor 56a is located at an end close to the side face 2c. The conductor 56d is adjacent to the coil conductor 55 in the direction D2.

The coil conductor 53 connects the internal conductor 6 and the conductor 52a. The conductor 56a connects the conductor 52a and the conductor 51a. The conductor 54a connects the conductor 51a and the conductor 52b. The conductor 56b connects the conductor 52b and the conductor 51b. The conductor 54b connects the conductor 51b and the conductor 52c. The conductor 56c connects the conductor 52c and the conductor 51c. The conductor 54c connects the conductor 51c and the conductor 52d. The conductor 56d connects the conductor 52d and the conductor 51d. The conductor 54d connects the conductor 51d and the conductor 52e. The coil conductor 55 connects the conductor 52e and the internal conductor 7.

A shortest distance between the side face 2e and the coil 5 may be shorter than a shortest distance between at least one of the pair of side faces 2c and 2d and the coil 5. As shown in FIG. 4, the shortest distance between the coil 5 and the side face 2e may be shorter than a shortest distance between the coil 5 and each of the pair of side faces 2c and 2d. The shortest distance between the coil 5 and the side face 2e may be shorter than a shortest distance between the coil 5 and the side face 2f.

As shown in FIG. 3, the coil 5 defines a space S at the center of the spiral shape. The coil axis AX of the coil 5 passes through the space S. The space S is located at the center of the electronic component 1 when viewed from the side faces 2c, 2d. In the electronic component 1, a part of the element body 2 is located in a region within the space S.

As shown in FIG. 3, a distancet1 between the side face 2e and the at least one coil conductor 52 in the direction D3 is shorter than a thickness t2 of the at least one coil conductor 52. The outer layer 21 constitutes a portion of the element body 2 from the side face 2e to the at least one coil conductor 52. The outer layer 21 is in contact with the at least one coil conductor 52. The distance t1 between the side face 2e and the at least one coil conductor 52 in the direction D3 corresponds to a thickness of the outer layer 21. The thickness t2 of the at least one coil conductor 52 may be a maximum value of the thicknesses of the plurality of conductors 52a to 52e included in the at least one coil conductor 52. The thickness t2 of the at least one coil conductor 52 may be equal to a thickness of the insulator layer 20 adjacent to the outer layer 21 among the plurality of insulator layers 20. In one example, the distance t1 between the side face 2e and the at least one coil conductor 52 in the direction D3 is 15 μm or less. The distance t1 between the side face 2e and the at least one coil conductor 52 in the direction D3 may be 15 μm or less and 2 μm or more. The outer layer 21 can be visually recognized when viewed from a direction orthogonal to the direction D3.

The pair of internal conductors 6 and 7 connect the pair of external conductors 3 and 4 to the coil 5. The internal conductor 6 is located between the external conductor 3 and the coil 5 in the direction D3. Specifically, the internal conductor 6 is located between the external conductor 3 and the coil conductor 53 of the coil 5 in the direction D3. The internal conductor 6 connects the external conductor 3 and the coil conductor 53 of the coil 5. In the actual electronic component 1, the coil conductor 53 and the internal conductor 6 are integrated to such an extent that their boundary is not visible. The internal conductor 7 is located between the external conductor 4 and the coil 5 in the direction D3. Specifically, the internal conductor 7 is located between the external conductor 4 and the coil conductor 55 of the coil 5 in the direction D3. The internal conductor 7 connects the external conductor 4 and the coil conductor 55 of the coil 5. In the actual electronic component 1, the coil conductor 55 and the internal conductor 7 are integrated to such an extent that their boundary is not visible.

As described above, a length of each of the pair of side faces 2c and 2d opposing each other in the direction D1 and a length of each of the pair of side faces 2e, 2f opposing each other in the direction D1 are equal. A length of each of the pair of end faces 2a and 2b opposing each other in the direction D3 and a length of each of the pair of side faces 2c and 2d opposing each other in the direction D3 are equal. A length of each of the pair of end faces 2a and 2b opposing each other in the direction D2 and a length of each of the pair of side faces 2e, 2f opposing each other in the direction D2 are equal.

Therefore, the length of each of the end faces 2a and 2b and the side faces 2c and 2d in the direction D3 is equal, and the length of each of the end faces 2a and 2b and the side faces 2e and 2f in the direction D2 is equal. As a result, in a configuration where the length d2 of each of the pair of end faces 2a and 2b opposing each other in the direction D3 in the direction D2 and the length d3 of each of the pair of end faces 2a and 2b opposing each other in the direction D3 in the direction D3 are equal, the length of the side faces 2c and 2d in the direction D3 and the length of the side faces 2e and 2f in the direction D2 are equal. Since the length of each side defining the side faces 2c and 2d is equal to the length of each side defining the side faces 2e and 2f, the side faces 2c, 2d, 2e, and 2f have the same shape.

In the one aspect described above, the surface color of the side face 2e is different from the surface color of the side face 2f and the surface color of each of the side faces 2c and 2d. Therefore, even if the side faces 2e, 2f, 2c, and 2d have the same shape, because the surface color of the side face 2e is different from the surface colors of each of the other side faces 2f, 2c, and 2d, the electronic component 1 facilitates confirmation of its orientation.

The element body 2 has a plurality of insulator layers 20 laminated along the direction D3. The plurality of insulator layers 20 include an outer layer 21 located at one end in the direction D3. The outer layer 21 constitutes the side face 2e. The surface color of the outer layer 21 is different from the surface color of each of the plurality of insulator layers 20 excluding the outer layer 21.

In the electronic component 1, the side face 2e, which has a surface color different from the other side faces 2f, 2c, and 2d, is constituted by the outer layer 21. Therefore, the surface color of the side face 2e can be made different from the surface colors of the other side faces 2f, 2c, and 2d.

The side face 2e is colored with a surface color different from the surface color of each of the side faces 2f, 2c, and 2d.

Since coloring changes the inherent color of the side face 2e, the effect of the surface state of the side face 2e can be reduced.

The outer layer 21 is colored with a surface color different from the surface color of each of the plurality of insulator layers 20 excluding the outer layer 21.

Since coloring changes the inherent color of the outer layer 21, the influence of the color due to the surface state of the outer layer 21 on the surface color of the outer layer 21 can be reduced.

The surface roughness Sa1 of the side face 2e is different from the surface roughness Sa3 of the side face 2f and the surface roughness Sa2 of each of the side faces 2c and 2d.

The surface color and the surface roughness are correlated. The color due to the surface state in the surface color changes according to the surface roughness. Therefore, by changing the surface roughness, the surface color of the side face 2e can be changed.

The electronic component 1 further includes a coil 5 located in the element body 2. The distance t1 between the side face 2e and the at least one coil conductor 52 in the direction D3 is shorter than the thickness t2 of the at least one coil conductor 52 in the direction D3. In one example, the distance t1 between the side face 2e and the at least one coil conductor 52 in the direction D3 is 15 μm or less.

The shorter the distance t1 between the side face 2e and the at least one coil conductor 52 in the direction D3, the easier it is to increase the inner diameter of the coil 5. The distance t1 between the side face 2e and the at least one coil conductor 52 in the direction D3 only needs to be large enough to the extent that the surface color of the side face 2e and the surface colors of the other side faces 2f, 2c, and 2d are different.

The present disclosure has been described in detail above based on its embodiments. However, the present disclosure is not limited to the above-described embodiments. The present disclosure can be modified in various ways without departing from the gist thereof.

The element body 2 may have transparency to visible light. In one example, the element body 2 may be translucent. A total light transmittance of the outer layer 21 may be different from a total light transmittance of each of the plurality of insulator layers 20 excluding the outer layer 21. The total light transmittance of the outer layer 21 may be smaller than the total light transmittance of each of the plurality of insulator layers 20 excluding the outer layer 21. The total light transmittance of the outer layer 21 may be larger than the total light transmittance of each of the plurality of insulator layers 20 excluding the outer layer 21.

The surface roughness Sa1 of the side face 2e may be 0.4 μm or less. The surface roughness Sa1 of the side face 2e may be 0.4 μm or less and 0.01 μm or more.

The electronic component 1 may not include the coil 5. The electronic component 1 is not limited to a coil component.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. An electronic component comprising:
an element body including a pair of end faces opposing each other in a first direction, a pair of first side faces opposing each other in a second direction orthogonal to the first direction, and a pair of second side faces opposing each other in a third direction orthogonal to the first direction and the second direction; and
a pair of external conductors on the element body,
wherein a length of each of the pair of end faces in the second direction and a length of each of the pair of end faces in the third direction are equal, and
a surface color of one of the pair of second side faces is different from a surface color of the other of the pair of second side faces and is different from a surface color of each of the pair of first side faces.

2. The electronic component according to claim 1, wherein
the one of the pair of second side faces is colored with the surface color different from the surface color of the other of the pair of second side faces and different from the surface color of each of the pair of first side faces.

3. The electronic component according to claim 1, wherein
a surface roughness of the one of the pair of second side faces is different from a surface roughness of the other of the pair of second side faces and is different from a surface roughness of each of the pair of first side faces.

4. The electronic component according to claim 1, wherein
the element body has a plurality of insulator layers laminated along the third direction,
the plurality of insulator layers include an outer layer located at one end in the third direction,
the outer layer includes the one of the pair of second side faces,
a surface color of the outer layer includes the surface color of the one of the pair of second side faces, and
the surface color of the outer layer is different from a surface color of each of the plurality of insulator layers excluding the outer layer.

5. The electronic component according to claim 1, further comprising:
a coil in the element body, wherein
the coil has at least one coil conductor adjacent to the one of the pair of second side faces, and
a distance between the one of the pair of second side faces and the at least one coil conductor in the third direction is shorter than a thickness of the at least one coil conductor in the third direction.

6. The electronic component according to claim 1, further comprising:
a coil in the element body, wherein
the coil has at least one coil conductor adjacent to the one of the pair of second side faces, and
a distance between the one of the pair of second side faces and the at least one coil conductor in the third direction is 15 μm or less.

7. The electronic component according to claim 2, further comprising:
a coil in the element body, wherein
the coil has at least one coil conductor adjacent to the one of the pair of second side faces, and
a distance between the one of the pair of second side faces and the at least one coil conductor in the third direction is shorter than a thickness of the at least one coil conductor in the third direction.

8. The electronic component according to claim 2, further comprising:
a coil in the element body, wherein
the coil has at least one coil conductor adjacent to the one of the pair of second side faces, and
a distance between the one of the pair of second side faces and the at least one coil conductor in the third direction is 15 μm or less.

9. The electronic component according to claim 3, further comprising:
a coil in the element body, wherein
the coil has at least one coil conductor adjacent to the one of the pair of second side faces, and
a distance between the one of the pair of second side faces and the at least one coil conductor in the third direction is shorter than a thickness of the at least one coil conductor in the third direction.

10. The electronic component according to claim 3, further comprising:
a coil in the element body, wherein
the coil has at least one coil conductor adjacent to the one of the pair of second side faces, and
a distance between the one of the pair of second side faces and the at least one coil conductor in the third direction is 15 μm or less.

11. The electronic component according to claim 4, wherein
at least one of the outer layer or each of the plurality of insulator layers excluding the outer layer is colored so that the surface color of the outer layer and the surface color of each of the plurality of insulator layers excluding the outer layer are different from each other.

12. The electronic component according to claim 4, further comprising:
a coil in the element body, wherein
the coil has at least one coil conductor adjacent to the one of the pair of second side faces, and
a distance between the one of the pair of second side faces and the at least one coil conductor in the third direction is shorter than a thickness of the at least one coil conductor in the third direction.

13. The electronic component according to claim 4, further comprising:
a coil in the element body, wherein
the coil has at least one coil conductor adjacent to the one of the pair of second side faces, and
a distance between the one of the pair of second side faces and the at least one coil conductor in the third direction is 15 μm or less.

14. The electronic component according to claim 5, wherein
a distance between the one of the pair of second side faces and the at least one coil conductor in the third direction is 15 μm or less.
